(19) United States
(12) Patent Application Publication
(10) Pub. No.: US 2026/0120475 A1
(43) Pub. Date: Apr. 30, 2026

(54) SYSTEMS AND METHODS FOR ENHANCING BIRD'S EYE VIEW REPRESENTATIONS WITH DIFFUSION MODEL SYSTEMS

(71) Applicant: Robert Bosch GmbH, Stuttgart (DE)

(72) Inventors: Xin YE, San Jose, CA (US); Burhaneddin YAMAN, San Jose, CA (US); Feng TAO, Cupertino, CA (US); Chenbin PAN, Sunnyvale, CA (US); Abhirup MALLIK, San Jose, CA (US); Liu REN, Saratoga, CA (US)

(21) Appl. No.: 18/933,232

(22) Filed: Oct. 31, 2024

(51) Int. Cl. G06V 20/56; B60W 60/00; G06T 5/70; G06V 10/25

(52) U.S. Cl. CPC G06V 20/56; B60W 60/001; G06T 5/70; G06V 10/25

(57) ABSTRACT

A Bird's Eye View (BEV)-based object detection framework for autonomous vehicles. The disclosed embodiments pretrain a diffusion model system on BEV representations generated from sensor data, such as cameras, LiDARs, and radars. The pretrained diffusion model system may be integrated into the BEV generation network to denoise BEV features through a supervision loss mechanism during training. This approach enhances the quality of BEV representations used in downstream tasks, such as object detection and trajectory prediction, without introducing any incremental computational cost during run-time.

### TECHNICAL FIELD

The present disclosure relates to systems and methods for enhancing Bird's Eye View (BEV) representations with diffusion model systems. The systems and methods disclosed herein may be applied to autonomous driving applications.

### BACKGROUND

Autonomous driving systems may rely on a range of sensory inputs to develop a comprehensive understanding of their surrounding environment. One of these representations is a Bird's Eye View (BEV), which provides a top-down, holistic perspective of the environment. BEV plays a role in enabling autonomous vehicles to perceive their surroundings, as it consolidates data from multiple sensors such as cameras, LiDARs, and radars. This information includes details about road layouts, lanes, intersections, and the positions of objects such as vehicles, pedestrians, and obstacles. Such data may help identify potential collision risks, predict object trajectories, and/or plan efficient routes.

BEV representations may be susceptible to noise introduced by the sensors generating the BEV representations. System noise, for example from cameras and LiDARs, can lead to imprecise localization and a reduction in the accuracy of the BEV features, which may negatively impacts downstream tasks such as perception, planning, and decision-making.

### SUMMARY

In one or more illustrative examples, a method for enhancing Bird's Eye View (BEV) feature quality in autonomous driving systems is disclosed. The method includes receiving BEV representations from a vehicle vision system, pretraining a diffusion model system on the BEV representations generated from sensor data, where the BEV representations undergo a noise-adding process (e.g., a noise-adding process defined by a Markov chain). The noise-adding process may involve applying iterative noise to BEV data and is controlled by a noise scheduler that adjusts the noise strength at each step. The diffusion model system may be trained to reduce or minimize a training objective by predicting the noise added during each step of the Markov chain, based on ground truth conditions such as class labels, object bounding box information, or layout details. Once pretrained, the diffusion model system may be used to denoise the BEV data by reversing the noise-adding process, producing refined BEV features. The refined BEV features may be used in one or more autonomous vehicle operations.

In one or more illustrative examples, the pretrained diffusion model system may be integrated into a BEV generation network during a fine-tuning stage. The integration process enhances the BEV feature representations by incorporating the diffusion model system into the network to provide supervision during training. In this stage, BEV features produced by the generation network may be fed into the diffusion model system, which denoises them. A supervision loss may be computed by comparing the denoised BEV features with the original BEV outputs from the network. The overall training process minimizes ore reduces a combined loss, which includes both the supervision loss provided by the diffusion model system and the loss associated with the downstream tasks, such as object detection, trajectory prediction, and path planning.

In one or more illustrative examples, the diffusion model system used in the pretraining stage may be a UNet-like neural network architecture serving as the noise prediction function. The pretraining of the diffusion model system may be governed by a noise schedule that controls the strength of the noise added during each step of the Markov chain. After pretraining, the diffusion model system may denoise BEV features efficiently without introducing incremental computational cost during runtime. This approach may ensure that the method can improve BEV quality while maintaining performance efficiency for real-time autonomous driving applications.

In one or more illustrative examples, a system for training a BEV generation network with a pretrained diffusion model system may include a sensor system for generating BEV data from various sensors, such as cameras, LiDARs, and radars. The system may include one or more processors and a memory storing instructions that, when executed, cause the system to pretrain a diffusion model system on the BEV data using the noise-adding process and ground truth conditions such as object labels, bounding boxes, or layout information. The processors may be configured to incorporate the pretrained diffusion model system into the BEV generation network to provide supervision during fine-tuning. During this fine-tuning, the diffusion model system denoises the BEV outputs from the network, and a supervision loss may be computed between the denoised BEV and the original BEV output. The system trains the BEV generation network by minimizing both the supervision loss and a task-specific loss, with the refined BEV features subsequently used for downstream tasks such as object detection, trajectory prediction, and route planning.

In one or more illustrative examples, the system may be further configured to train the BEV generation network in an end-to-end manner, ensuring the minimization of both the supervision loss provided by the diffusion model system and the loss associated with the downstream tasks. This training process may improve the overall performance of the autonomous driving system without incurring additional computational costs during runtime. The BEV generation network may be optimized for downstream tasks such as object detection, trajectory prediction, and path planning, leveraging the high-quality, denoised BEV features generated by the diffusion model system.

In one or more illustrative examples, a non-transitory computer-readable medium may include instructions that, when executed by a processor, cause the system to perform operations including pretraining a diffusion model system on BEV data using a noise-adding process (e.g., a Markov chain noise-adding process) and ground truth conditions such as object labels or layout details. The medium may further include instructions for integrating the pretrained diffusion model system into a BEV generation network during the fine-tuning stage. During this stage, the diffusion model system denoises the BEV outputs from the generation network, and a supervision loss may be calculated between the denoised BEV data and the original BEV outputs. The combined loss, consisting of the supervision loss and the downstream task loss, may be minimized during training to improve the quality of BEV features and enhance the performance of downstream tasks in autonomous driving systems.

### BRIEF DESCRIPTION OF THE DRAWINGS

FIG. 1 is a schematic diagram of a vehicle system;

FIG. 2 is a diagram of a bird eye view enhancement pipeline leveraging diffusion model systems;

FIG. 3 is a flowchart of a method for bird eye view enhancement; and

FIG. 4 illustrates an exemplar embodiment of a general computer system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Bird's Eye View (BEV) representations, generated through a spatio-temporal fusion of multi-view images, may provide a comprehensive understanding of the surrounding environment. These representations may be used in autonomous driving tasks such as perception, prediction, and planning, with the quality of BEV features directly influencing the performance of these tasks. However, due to sensor limitations, including noise from cameras and LiDAR, BEV representations may suffer from inaccuracies, which can hinder precise object localization and reduce the effectiveness of downstream operations. Consequently, there remains a need to enhance the overall performance of autonomous driving systems by reducing noise. To mitigate these challenges, one or more embodiments disclose a training framework that employs diffusion model systems with ground truth supervision to denoise and enhance BEV representations. Notably, one or more embodiments operate exclusively during training and incur no additional computational cost during inference, thereby enabling improved efficiencies and performance in autonomous driving systems.

In autonomous driving systems, BEV representations serve as the primary source of information for end-to-end autonomous driving, providing a top-down, holistic perspective of the surrounding environment. BEV maps are generated from various sensors, including cameras, LiDAR, and radar, and convey critical information such as road layouts, lanes, intersections, and the positions of vehicles, pedestrians, and obstacles. This detailed view enables the system to identify potential collision risks, anticipate future actions, predict object trajectories, and plan efficient routes. The accuracy and richness of the BEV feature space are crucial for ensuring smooth and reliable autonomous driving.

However, BEV representations are inherently noisy due to sensor limitations, such as system noise from cameras or LiDAR. This noise leads to imprecise object localization, which in turn may degrade the performance of downstream tasks such as perception and planning. Therefore, improving the quality of BEV representations by reducing noise may enhance the overall performance of autonomous driving systems.

To address one or more of these challenges, diffusion model systems, known for their strong denoising capabilities, may be utilized. Diffusion model systems are a class of generative models that learn to denoise or generate data by reversing a noise addition process. In this process, noise may be incrementally added to the data, and the model may be trained to reverse this process, recovering the original data from its noisy version. Due to their ability to model complex data distributions through iterative denoising, diffusion model systems have proven effective in tasks such as image synthesis, super-resolution, and text-to-image generation.

In one or more embodiments, a training framework is disclosed that leverages diffusion model systems to denoise and enhance the quality of BEV features. The system may operate in two stages. In a first stage, a diffusion model system may be pretrained on BEV representations. In a second stage, the pretrained diffusion model system may be integrated into the BEV training or fine-tuning framework to further improve the quality of BEV features. These enhanced BEV features are then fed into downstream tasks to boost their performance.

The first stage of the diffusion-based BEV enhancement strategy for autonomous driving tasks pretrains a diffusion model system on BEVs. Given data x0∈X, which may be generated from a pretrained BEV generator framework, a Markov chain can be defined as in Equation (1) below:

$$q ( {x}_{t} \vert {x}_{t - 1} ) = 𝒩 ( {x}_{t} ; \sqrt{1 - {β}_{t}} {x}_{t - 1} , {β}_{t} I ) , \qquad ( 1 )$$

where t=1, . . . , T, T is the total number of steps. βt is a coefficient that controls the noise strength in step t. The iterative noise adding process which enables getting noisy sample at step t directly from the input data x0 can be modeled as set forth in Equation (2) below:

$${x}_{t} = \sqrt{{\overline{α}}_{t}} {x}_{0} + \sqrt{1 - {\overline{α}}_{t}} ϵ , ϵ ∼ 𝒩 ( 0 , I ) ) , \qquad ( 2 )$$

where

$${\overline{α}}_{t} = {\prod }_{i = 1}^{t} ( 1 - {β}_{t} )$$

is the noise scheduler. Equation (2) weighs the input data and noise sampled from gaussian distribution based on a noise scheduler. Diffusion model systems learn the distribution of dataset X by minimizing the training objective.

The training objective can be written as set forth in Equation (3) below:

$${arg min}_{θ} {𝔼}_{{x}_{0} , ϵ ∼ 𝒩 ( 0 , I ) , t , c} [ {‖ ϵ - {ϵ}_{θ} ( {x}_{t} , t , c ) ‖}_{2}^{2} ] , \qquad ( 3 )$$

εθ(·) is a UNet-like neural network architecture that serves as noise prediction function, and c is the conditions. In one or more embodiments, c is the ground truth conditions such as class label, object bounding box information, or layout. An example of such a condition is given below as set forth in Equation (4):

$$ground {truth}_{condition} = “ This object is \{ a construction vehicle \} . Its 3 d bounding box is \{ cx , cy , w , l , cz , h , rotation \} . ” \qquad ( 4 )$$

The text template provided in Equation (4) is exemplar and it may be altered with other text templates or other ground truth conditions such as ground truth layout. The pretrained diffusion model system can denoise the noisy BEV by reversing the noise-adding process.

The second stage aims to enhance the BEV representations by a joint training or fine-tuning BEV formation network with diffusion model systems pretrained in the first stage. In one or more embodiments, a training only plug-in mechanism to incorporate diffusion model systems to provide a supervision loss to generated the BEV may be employed. The methodology proposed may be a training only plug-in approach. Thus, in one or more embodiments, the approach does not introduce any extra cost in run-time.

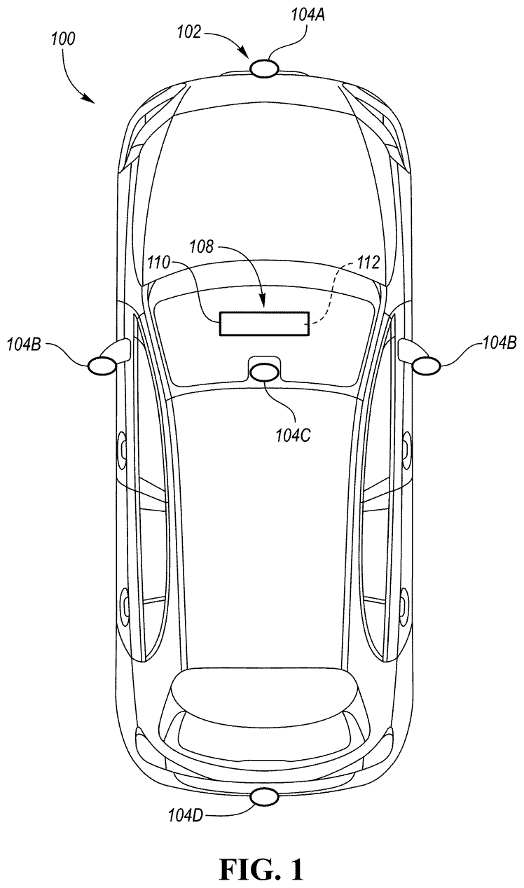

FIG. 1 illustrates a vehicle system 100 that implements an architecture of one or more embodiments for enhanced BEV processing. The vehicle system 100 includes a vision system 102 integrated into a vehicle body structure that enables comprehensive environmental monitoring and autonomous driving capabilities.

The vision system 102 includes a plurality of vision sensors 104A-104D strategically positioned around the vehicle to provide complete perimeter coverage. Vision sensor 104A may be mounted at the front of the vehicle, vision sensors 104B are mounted on opposite sides of the vehicle, and vision sensor 104D may be mounted at the rear of the vehicle. In various embodiments, the number and configuration of sensors in the vision system 102 may vary. A control unit 108 may be mounted within a cabin area of the vehicle system 100. In one configuration, the control unit 108 may be integrated into a dashboard assembly. The control unit 108 includes a display 110 that provides visual output of the processed BEV representations and autonomous driving information to occupants of the vehicle system 100. Vision sensors 104A-104D may be communicatively coupled to the control unit 108 through appropriate data buses or wireless connections, enabling real-time transmission of image data for processing. The vision sensor configuration ensures overlapping fields of view, facilitating robust environmental perception and accurate BEV generation. Each vision sensor 104A-104D may include internal processing capabilities for initial image preprocessing before transmission to the control unit 108. The control unit 108 may further include an operable memory 112.

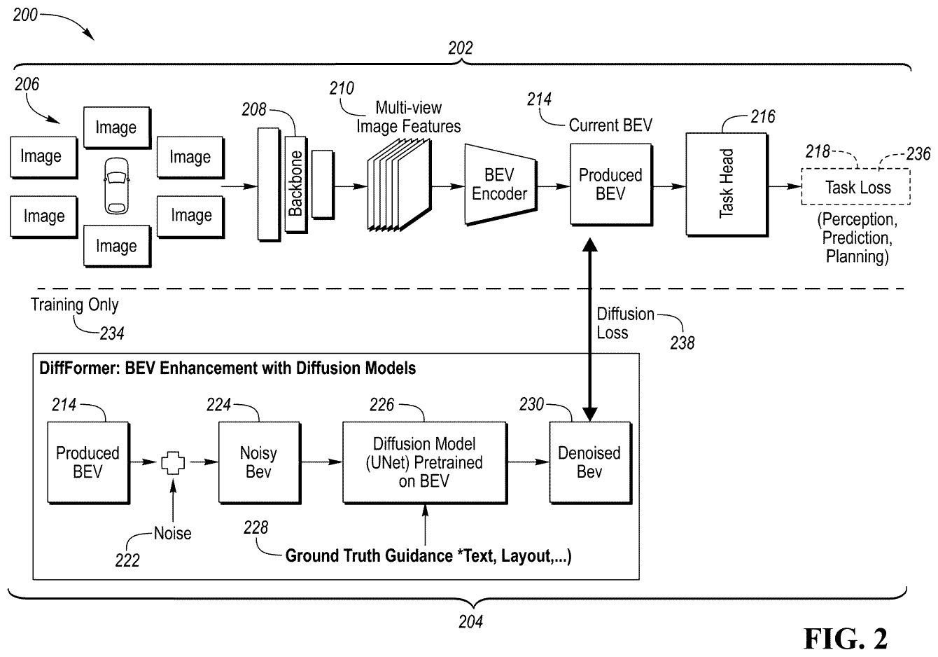

The described vehicle system 100 provides the hardware infrastructure necessary to implement the enhancement framework detailed in FIG. 2, enabling improved BEV representations for autonomous driving applications while maintaining practical deployment efficiency through its training-only enhancement approach.

FIG. 2 illustrates a system 200 for enhancing BEV representations in autonomous driving applications. The system comprises two primary sections: an upper processing pipeline 202 for BEV generation and task execution, and a lower enhancement pipeline 204 implementing an architecture of one or more embodiments.

The upper processing pipeline 202 begins with a multi-view image input system 206 that receives multiple camera views captured from various positions around a vehicle. These images are processed through a backbone network 208, which extracts multi-view image features 210. The extracted features are then passed to a BEV encoder 212 that generates a produced BEV representation 214. This BEV representation may be subsequently processed by a task head 216 that outputs task-specific loss results 218 for perception, prediction, and planning operations.

The lower enhancement pipeline 204, depicted in the shaded region of FIG. 2, represents an enhancement framework of one or more embodiments. This framework begins with the produced BEV 214 from the upper pipeline, which serves as input to the enhancement process. A noise injection module 220 combines the produced BEV with random noise 222 to generate a noisy BEV representation 224. This noisy BEV 224 may then be processed by a pretrained diffusion model system 226 implemented using a UNet architecture.

The diffusion model system 226 may receive additional input from a ground truth guidance system 228 that can provide various forms of guidance including, but not limited to, text descriptions and layout information. The diffusion model system processes the noisy BEV under the influence of this guidance to produce a denoised BEV output 230.

A key feature of the system may be the diffusion loss feedback path 232 that connects the denoised BEV output 230 back to the produced BEV 214. This feedback mechanism generates a diffusion loss signal that may be incorporated into the training process, as indicated by the “Training only” designation 234, this enhancement framework 204 may be active only during the training phase and adds no computational overhead during inference time according to one or more embodiments.

The combined loss function of the system includes both the task-specific loss 236 from the upper pipeline 202 and the diffusion loss 238 from the enhancement framework 204, enabling improved BEV quality while maintaining computational efficiency during deployment.

In one embodiment, the vision sensors 104A-104D in FIG. 1 are high-resolution digital cameras capable of capturing real-time image data under various lighting and weather conditions. The sensor in the vision system 102 may also include other types of sensors, such as LiDAR and radar utilized individually or in combination. The vision sensors 104A-104D provide the multi-view image input system 206 and provide the raw image data for a processing pipeline of one or more embodiments.

The display 110 may show both the initial produced BEV 214 and, during system development and training, the enhanced denoised BEV 230 generated by the system 200. The operable memory 112 may include the necessary software and computational models for implementing the system 200. The operable memory 112 may contain the backbone network 208, BEV encoder 212, task head 216, and during training, the diffusion model system 226 components. The operable memory 112 may be configured with sufficient capacity and processing speed to execute both the processing pipeline 202 for BEV generation and task execution, and the enhancement pipeline 204 implementing the architecture of one or more embodiments.

The processing pipeline 202 for BEV generation and task execution shows a high-level overview of the BEV representations used for autonomous driving tasks in one or more embodiments. The model includes BEV encoder 212 followed by task head 216 may be trained in an end-to-end manner with an objective of minimizing downstream task loss 236. The training loss function can be defined by Equation (5) as set forth below:

$$Loss = {Loss}_{task} \qquad ( 5 )$$

The enhancement pipeline 204 implementing the architecture of one or more embodiments takes input BEV obtained from BEV encoder 212, and denoises it by reversing the noise-adding process through the diffusion model system 226. Subsequently, the supervision loss between the denoised BEV 230 and the input BEV 214 from the BEV encoder network may be conducted. The supervision loss 238 represented as Loss_{diffusion} may be included as an additional loss in the training process. The process can be represented as follows in Equation (6):

$$Loss = {Loss}_{task} + {Loss}_{diffusion} \qquad ( 6 )$$

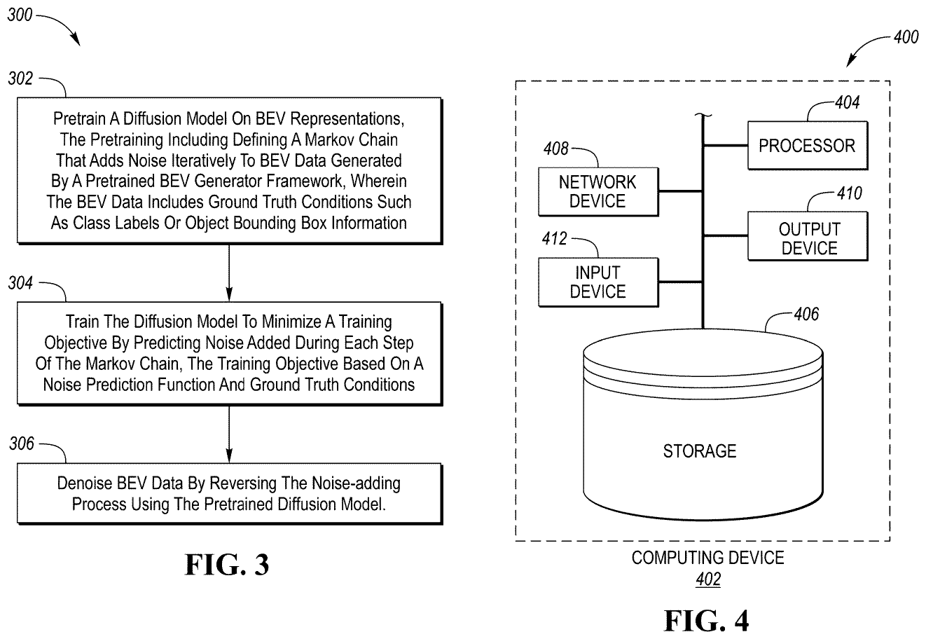

FIG. 3 illustrates a flowchart 300 for implementing the training process of one or more embodiments to enhance BEV representations for autonomous driving applications. At step 302, the method begins with pretraining a diffusion model system on BEV representations. This pretraining process includes defining a Markov chain that systematically adds noise in an iterative manner to BEV data. The BEV data may be initially generated by a pretrained BEV generator framework, such as the vision system 102 and processing pipeline 202 described in FIG. 1 and FIG. 2. The BEV data incorporates ground truth conditions, which may include text-based descriptions of objects and their associated 3D bounding box information. Additionally, these ground truth conditions may incorporate ground truth layout information of the environment to provide comprehensive scene understanding.

The process continues at step 304, where the diffusion model system may be trained to minimize a specific training objective. The diffusion model system includes a UNet-like neural network architecture that serves as a noise prediction function, with the training objective being to minimize the discrepancy between predicted noise and the noise added to the BEV data. A noise scheduler controls the strength of noise added during each step of the Markov chain, with the noise sampled from a Gaussian distribution and weighed according to the scheduler. The diffusion model system may be trained for a predefined number of steps, and the total number of steps in the noise-adding process may be defined by a noise schedule that adapts based on training progress.

At step 306, the method concludes with the denoising of BEV data through a reverse process that systematically removes the noise previously added. This denoising operation may be performed using the pretrained diffusion model system that was developed and refined in steps 302 and 304. Step 306 produces the denoised BEV output 230 as shown in FIG. 2, which is then used to generate the diffusion loss 238 for training the overall system.

The pretrained diffusion model system is subsequently incorporated into a BEV generation network during a fine-tuning stage, wherein the BEV generation network is trained end-to-end with a downstream task loss. During step 306, the pretrained diffusion model system provides supervision by denoising the BEV output from the BEV generation network, and a supervision loss may be computed between the denoised BEV and the original BEV output. The overall training loss function may be calculated as a sum of the downstream task loss and the supervision loss provided by the diffusion model system.

The BEV generation network may be configured to perform multiple downstream autonomous driving tasks including object detection, trajectory prediction, and path planning. The BEV representations processed by the network include data from a combination of sensors including cameras, LiDARs, and radars, enabling comprehensive environmental perception and analysis.

The method outlined in flowchart 300 represents a training procedure of the system 200 as shown in FIG. 2, enabling the enhancement of BEV representations through a diffusion-based denoising approach.

FIG. 4 shows an example 400 of a computing device 402 for implementing a BEV enhancement system according to one or more embodiments. The computing device 402 may be contained within the control unit 108 of the vehicle system 100. As shown, the computing device 402 includes a processor 404 that may be operatively connected to a storage 406, a network device 408, an output device 410, and an input device 412. It should be noted that this may merely be an example, and computing devices 402 with more, fewer, or different components may be used.

The processor 404 may include one or more integrated circuits that implement the functionality of a central processing unit (CPU) and/or graphics processing unit (GPU). In some examples, the processors 404 are a system on a chip (SoC) that integrates the functionality of the CPU and GPU. The SoC may optionally include other components such as, for example, the storage 406 and the network device 408 into a single integrated device. In other examples, the CPU and GPU are connected to each other via a peripheral connection device such as peripheral component interconnect (PCI) express or another suitable peripheral data connection. In one example, the CPU may be a commercially available central processing device that implements an instruction set such as one of the x86, ARM, Power, or microprocessor without interlocked pipeline stage (MIPS) instruction set families.

Regardless of the specifics, during operation the processor 404 executes stored program instructions that are retrieved from the storage 406. The stored program instructions, accordingly, include software that controls the operation of the processors 404 to perform the DiffFormer operations described herein. The processor 404 can execute complex algorithms involved in BEV enhancement, diffusion model system training, and autonomous driving tasks. The storage 406 may include both non-volatile memory and volatile memory devices. The non-volatile memory includes solid-state memories, such as not and (NAND) flash memory, magnetic and optical storage media, or any other suitable data storage device that retains data when the system may be deactivated or loses electrical power. The volatile memory includes static and dynamic random-access memory (RAM) that stores program instructions and data during operation of the DiffFormer framework. The network device 408 can be in communication with the vision system 102 storing image data received in the storage 406. Alternatively, the storage 406 may already contain image data from the vision system 102.

The GPU may include hardware and software for display of at least two-dimensional (2D) and optionally 3D graphics to the output device 410. The output device may be coupled with the display 110 of the vehicle system 100. The output device 410 may be configured to present data from vision system 102 and the results of the BEV enhancement process in an understandable format for human operators. The output device 410 may include a graphical or visual display device, such as an electronic display screen, projector, printer, or any other suitable device that reproduces a graphical display. As another example, the output device 410 may include an audio device, such as a loudspeaker or headphone. As yet a further example, the output device 410 may include a tactile device, such as a mechanically raiseable device that may, in an example, be configured to display braille or another physical output that may be touched to provide information to a user.

The input device 412 may include any of various devices that enable the computing device 402 to receive control input from users. The input device 412 enables users to interact with the computing device, to configure the diffusion model system training process, adjust ground truth conditions, and refine operational parameters of the model based on performance evaluations. Examples of suitable input devices that receive human interface inputs may include keyboards, mice, trackballs, touchscreens, voice input devices, graphics tablets, and the like.

The network devices 408 may each include any of various devices that enable the devices to send and/or receive data from external devices over networks. Examples of suitable network devices 408 include an Ethernet interface, a Wi-Fi transceiver, a cellular transceiver, or a BLUETOOTH or BLE transceiver, UWB transceiver, or other network adapter or peripheral interconnection device that receives data from the vision sensors 104A-104D, which can be useful for receiving large sets of image data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuit (ASIC), field-programmable gate array (FPGA), state machines, controllers or other hardware components or devices, or a combination of hardware, software, and firmware components.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method, comprising:
receiving Bird's Eye View (BEV) representations from a vehicle vision system;
pretraining a diffusion model system on the Bird's Eye View (BEV) representations to obtain a pretrained diffusion model system, the pretraining including adding noise iteratively to BEV data generated by a pretrained BEV generator framework, wherein the BEV data includes ground truth conditions;
training the diffusion model system in association with a training objective by predicting noise added during each iterative step of adding noise to the BEV data, the training objective is based on a noise prediction function and ground truth conditions; and
denoising the BEV data by reversing the noise-adding process using the pretrained diffusion model system to obtain denoised BEV data for use in one or more autonomous vehicle operations.

2. The method of claim 1, wherein the ground truth conditions include text-based descriptions of objects and their associated 3D bounding box information.

3. The method of claim 1, wherein the ground truth conditions include ground truth layout information of an environment.

4. The method of claim 1, further comprising:
incorporating the pretrained diffusion model system into a BEV generation network during a fine-tuning stage, wherein the BEV generation network is trained end-to-end with a downstream task loss.

5. The method of claim 4, wherein the pretrained diffusion model system provides supervision by denoising the BEV output from the BEV generation network, and computes a supervision loss between the denoised BEV and the original BEV output.

6. The method of claim 4, wherein the overall training loss function is a sum of the downstream task loss and the supervision loss provided by the diffusion model system.

7. The method of claim 4, wherein the BEV generation network is configured to perform the one or more autonomous vehicle operations including object detection, trajectory prediction, and path planning.

8. The method of claim 1, wherein the diffusion model system is a UNet neural network architecture serving as a noise prediction function, with the training objective being to minimize the discrepancy between predicted noise and the noise added to the BEV data.

9. The method of claim 1, further comprising:
defining a noise scheduler that controls the strength of noise added during each iterative step of the BEV data, with the noise sampled from a Gaussian distribution and weighed according to the scheduler.

10. The method of claim 1, wherein the diffusion model system is trained for a predefined number of steps, and the total number of steps in the noise-adding process is defined by a noise schedule that adapts based on training progress.

11. The method of claim 1, wherein the vehicle vision system includes one or more sensors including cameras, LiDARs, and radars.

12. A non-transitory computer-readable medium, comprising instructions that, when executed by a processor, cause a system to perform operations comprising:
pretraining a diffusion model system on Bird's Eye View (BEV) data using a noise-adding process and ground truth conditions;
integrating the pretrained diffusion model system into a BEV generation network to provide supervision during training by denoising the generated BEV data; and
computing a supervision loss between the denoised BEV data and the generated BEV data.

13. The non-transitory computer-readable medium of claim 12, wherein the ground truth conditions include one or more of text-based descriptions of objects and their bounding box information.

14. The non-transitory computer-readable medium of claim 12, wherein the pretrained diffusion model system denoises BEV features during the fine-tuning stage of the BEV generation network.

15. The non-transitory computer-readable medium of claim 12, wherein the operations further comprise training the BEV generation network in an end-to-end manner, with the supervision loss provided by the diffusion model system.

16. The non-transitory computer-readable medium of claim 12, wherein the BEV generation network is configured to minimize a downstream task loss, the tasks including object detection and trajectory prediction.

17. The non-transitory computer-readable medium of claim 12, wherein the operations further comprise projecting the denoised BEV representations onto a two-dimensional plane for use in one or more autonomous vehicle operations.

18. A system, comprising:
one or more processors;
a memory storing instructions that, when executed by the processors, cause the system to perform operations comprising:
pretraining a diffusion model system on Bird's Eye View (BEV) representations using a noise-adding process;
fine-tuning a BEV generation network by incorporating the pretrained diffusion model system, wherein the diffusion model system denoises BEV outputs and provides supervision through a supervision loss during training; and
outputting denoised BEV features for use in downstream autonomous driving tasks.

19. The system of claim 18, wherein the BEV generation network is trained with an end-to-end training process to reduce both a downstream task loss and a supervision loss provided by the diffusion model system.

20. The system of claim 18, wherein the noise-adding process utilizes a Markov chain.
